(19) United States
(12) Patent Application Publication
(10) Pub. No.: US 2008/0282291 A1
(43) Pub. Date: Nov. 13, 2008

(54) TV content search system and method with multi-field search and display

(76) Inventor: David L. Henty, Newport Beach, CA (US)

Correspondence Address: David L. Henty;Suite 1150, 19900 MacArthur Blvd., Irvine, CA, 92612, US

(21) Appl. No.: 12/151,026

(22) Filed: May 2, 2008

Related U.S. Application Data
(60) Provisional application No. 60/927,762, filed on May 4, 2007.

(51) Int. Cl. H04N 5/445; G06F 17/30

(52) U.S. Cl. 725/44; 707/3; 707/E17.014

(57) ABSTRACT

A search based TV interface system and method is disclosed. Search results are dynamically displayed based on search parameters and/or time. A dynamically adjusted grid may be provided which collapses to a list if a minimum grid size is not met. Search results may also be dynamically displayed organized by category.

### RELATED APPLICATION INFORMATION

The present application claims priority to provisional application Ser. No. 60/927,762 filed May 4, 2007, the disclosure of which is incorporated herein by reference in its entirety.

### BACKGROUND OF THE INVENTION

1. Field of the Invention

The present invention relates to TV interfaces and control systems and methods for controlling entertainment systems employing a TV as a display device. More particularly the present invention relates to systems and methods for search and display of TV accessible content.

2. Description of the Prior Art and Related Information Modern TV based entertainment systems have the ability to access a large variety of content. Such content ranges from large numbers of digital TV channels, movies available through online pay per view or other subscription access services via cable or satellite, other online available media, as well as various locally stored media such as audio, pictures and video, and internet access. Accessing such content efficiently is impossible without employing a search feature of some type. At the same time TV interfaces are designed for ease of use with remote controls with well known control buttons, such as Up-Down-Left-Right (UDLR) and Select.

Search techniques of various complexity are known and in TV applications are typically kept simple due to the difficulty of text entry with remote controls. Usually a search category is selected and search results are displayed and scrolled through using the UDLR controls on the remote. For example, a search menu may lead to a category such as movies or sports and the search commences from there. This is easy to use with a remote control with UDLR inputs but requires the additional time to scroll through menu layers to get to the desired search category/field. This becomes more and more problematic as the number of field/categories increase making menus undesirably multi-layered and complex to navigate.

Accordingly a need exists for an easier way to search and display results in TV applications.

### SUMMARY OF THE INVENTION

In a first aspect the present invention provides a method for searching and displaying content in a TV environment comprising entering text into a search menu in response to text entry from a remote control or keyboard, and searching TV content including programs having varying start times based on the entered text. The method further comprises displaying the search results on a menu on the TV screen in a list format if the number of search results is less than a predetermined number and displaying the search results on menu on the TV screen in a time based grid format if the number of search results is greater than said predetermined number.

In another aspect the present invention provides a method for searching and displaying content in a TV environment comprising entering text into a search menu in response to text entry from a remote control or keyboard, searching video content including plural categories of content based on the categories selected by the entered text, and displaying the search results on a menu on the TV screen in a format with one or more separate lists or grids for each category.

In another aspect the present invention provides a method for searching and displaying content in a TV environment, comprising entering text into a search menu in response to text entry from a remote control or keyboard, searching video content including video content having varying start times and video content having no fixed start time based on the entered text, and displaying the search results on a menu on the TV screen in a list format for the search results having no fixed start time and in a time based grid format for the search results having varying start times.

In another aspect the present invention provides a method for searching and displaying content in a TV environment, comprising entering text into a search menu in response to text entry from a remote control or keyboard, the search parameters covering plural separate search fields based on search codes and keyword searches, and displaying the search results on a menu on the TV screen in dynamically adjusted grid format having varying start times with channels and time slots removed for grid results without matching content and satisfying a grid display criteria.

Further aspects of the invention will be appreciated from the following detailed description of the invention.

### BRIEF DESCRIPTION OF THE DRAWINGS

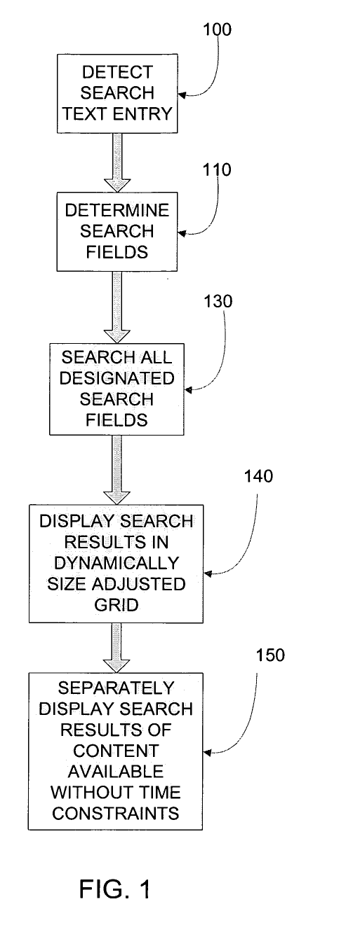

In FIG. 1 a flow diagram of a search control method in accordance with the invention is illustrated.

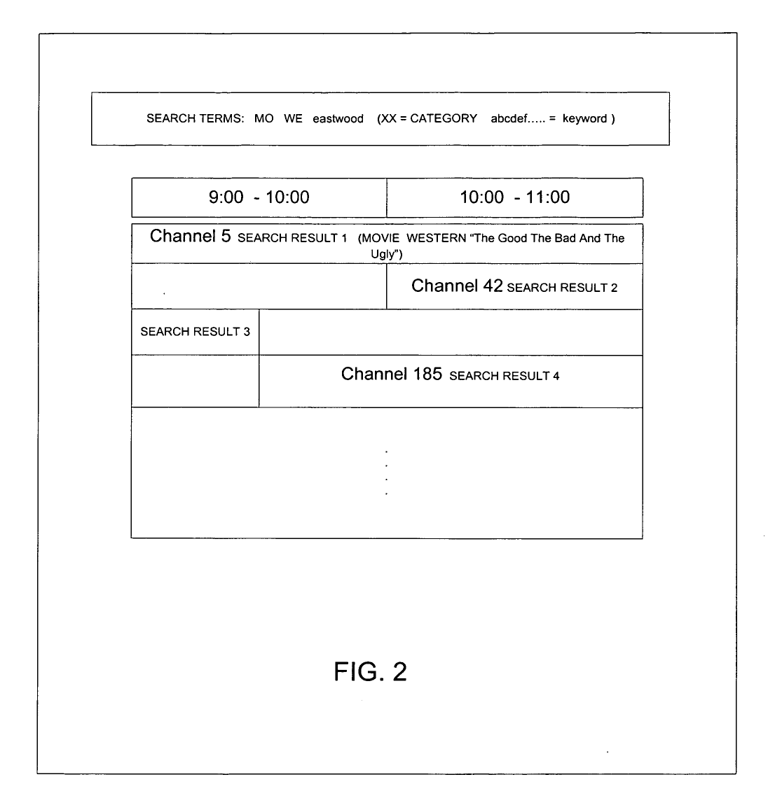

In FIG. 2 an example of a search menu with search results in accordance with the invention is illustrated.

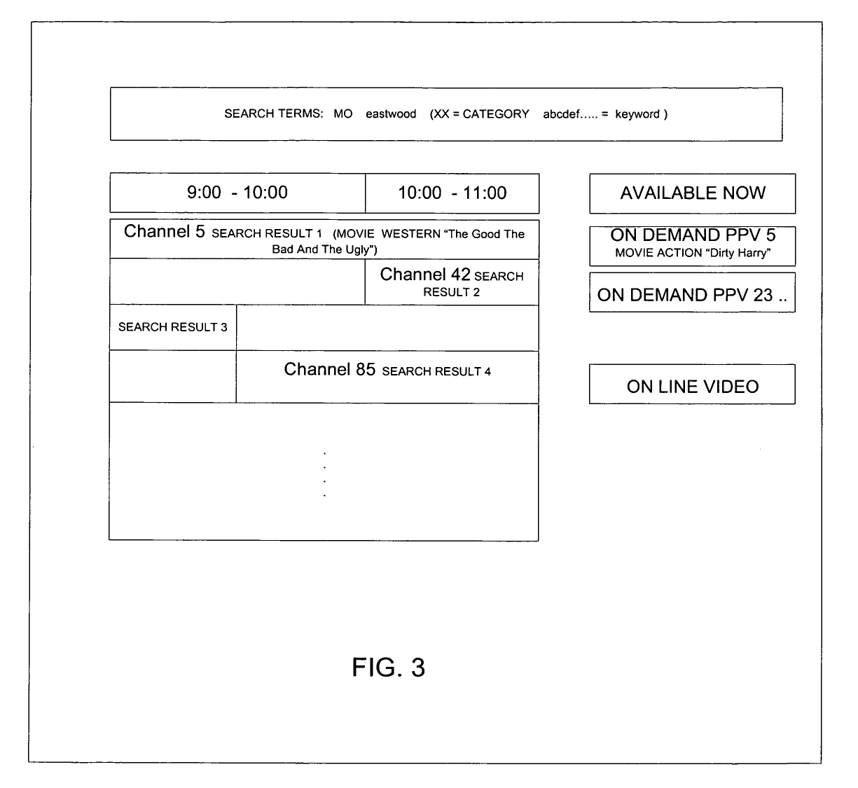

In FIG. 3 an example of a search menu with search results in accordance with an alternate embodiment of the invention is illustrated.

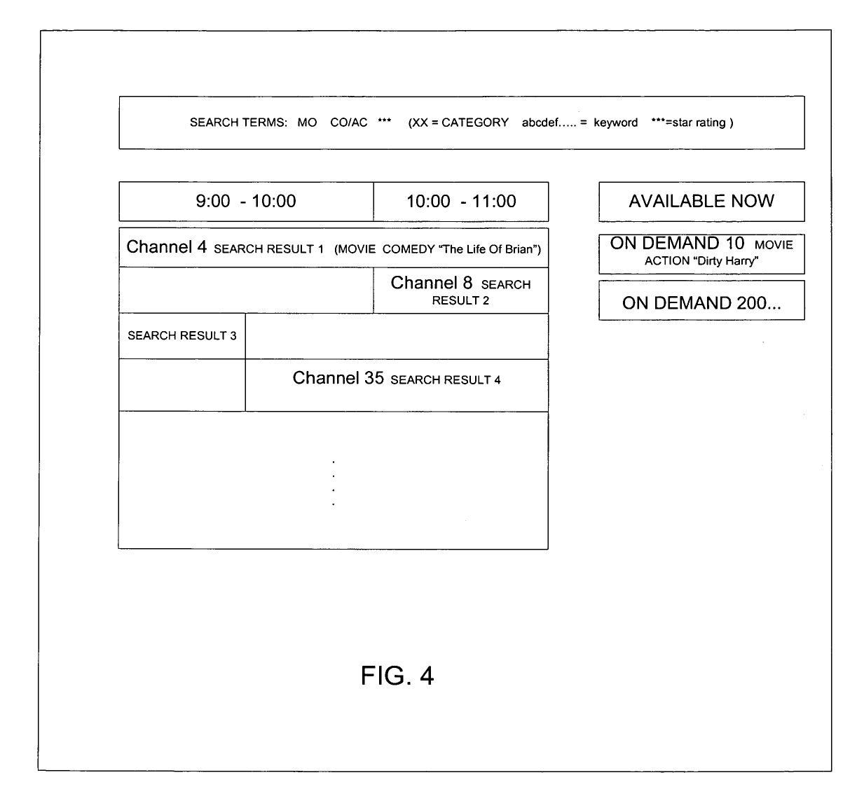

In FIG. 4 another example of a search menu with search results in accordance with an embodiment of the invention is illustrated.

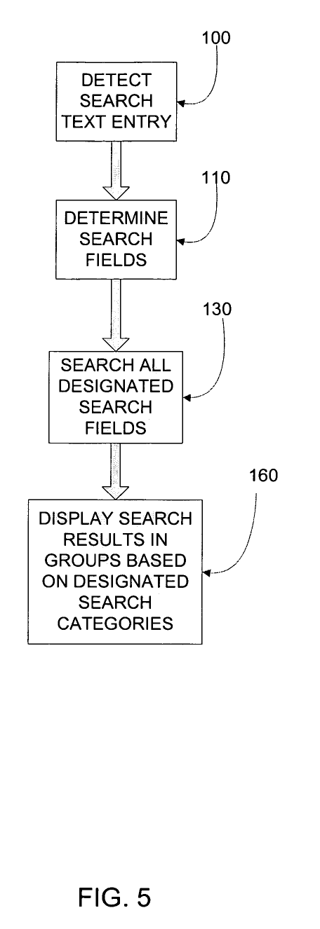

In FIG. 5 a flow diagram of a search control method in accordance with another aspect of the invention is illustrated.

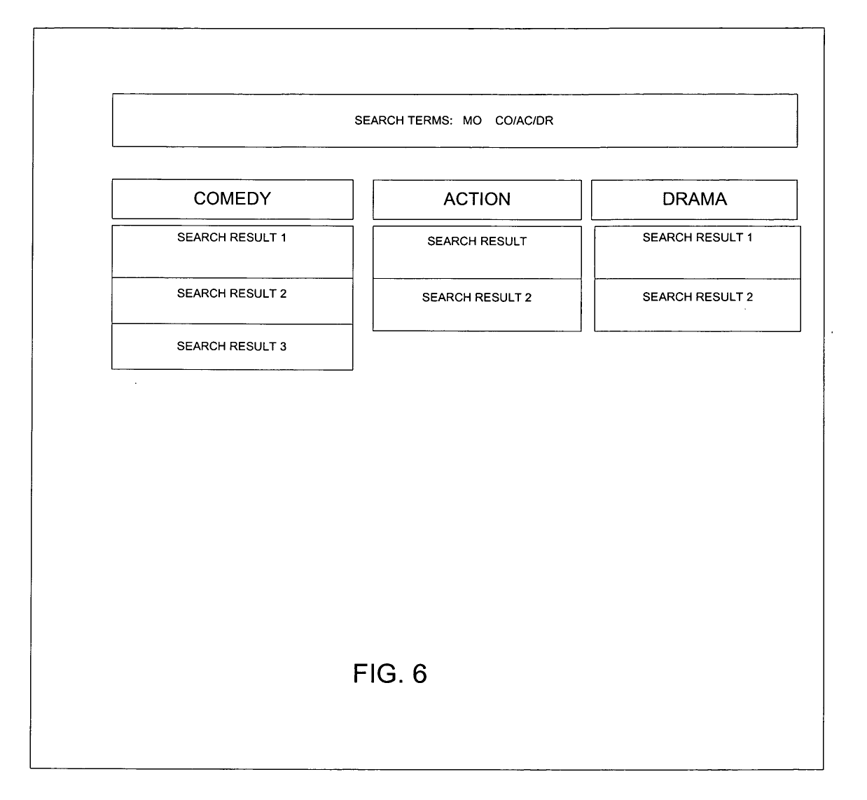

In FIG. 6 an example of a search menu with search results in accordance with an embodiment of the invention employing the search control method of FIG. 5 is illustrated.

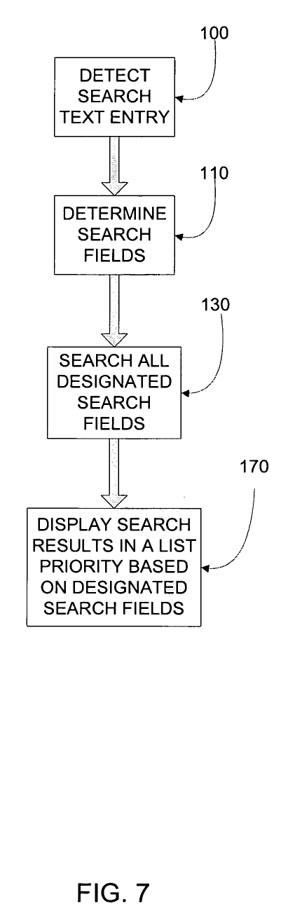

In FIG. 7 a flow diagram of a search control method in accordance with another aspect of the invention is illustrated.

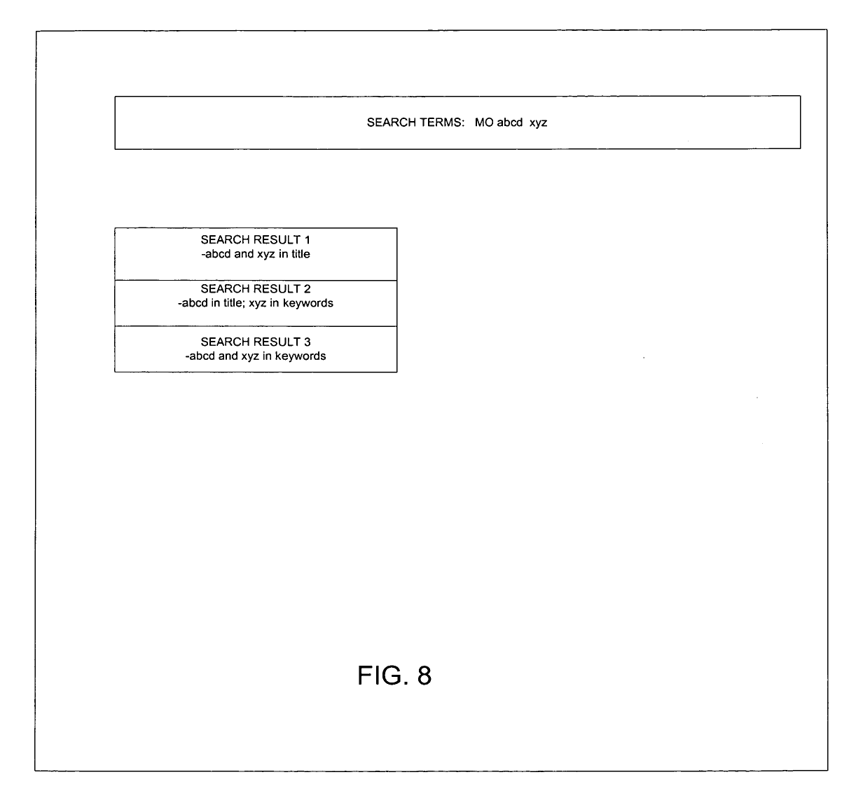

In FIG. 8 an example of a search menu with search results in accordance with an embodiment of the invention employing the search control method of FIG. 7 is illustrated.

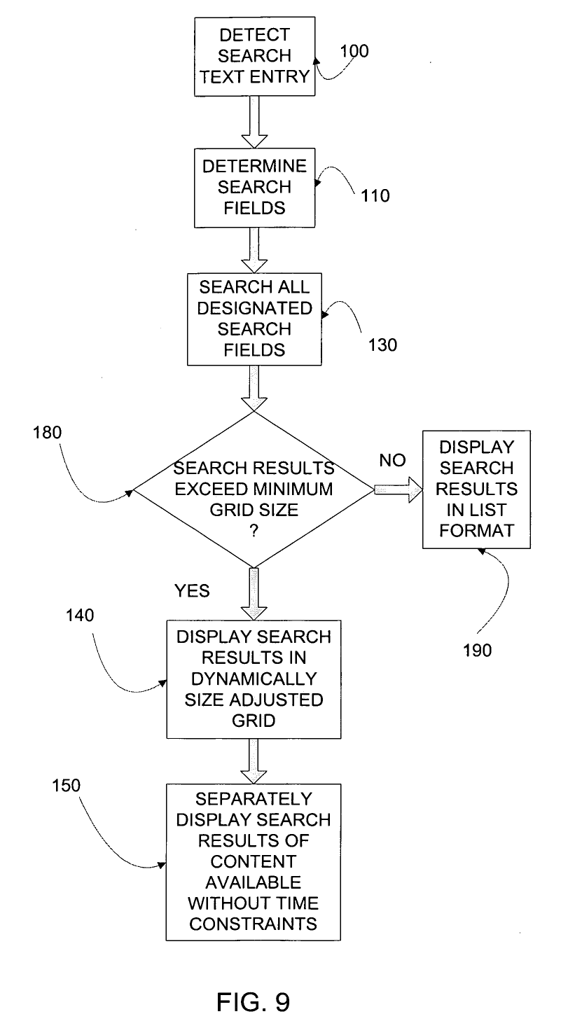

In FIG. 9 a flow diagram of a search control method in accordance with another aspect of the invention is illustrated.

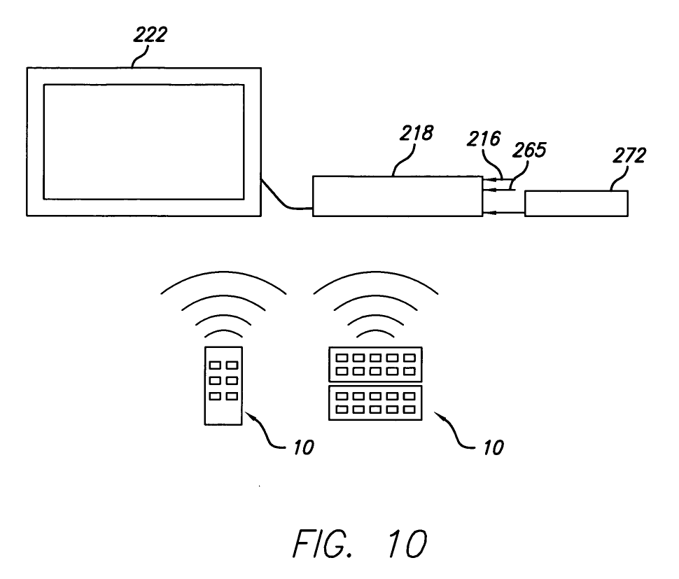

In FIG. 10 an improved entertainment system employing the search features in accordance with the present invention is illustrated.

### DETAILED DESCRIPTION OF THE INVENTION

U.S. Pat. Nos. 6,094,156 ('156 patent) and U.S. Pat. No. 7,123,242 ('242 patent) are incorporated herein by reference in their entirety. Pending patent application Ser. No. 12/077,891 filed Mar. 21, 2008 and patent application Ser. No. 12/080535 filed Apr. 3, 2008, are also incorporated herein by reference in their entirety. In the above noted '156 and '242 patents a folding remote control system and method with a keyboard configured on the inner surfaces of the folding remote are disclosed. This system and method allows easy text entry when desired by opening the folding remote and using the keyboard within the remote. The remote also has conventional UDLR buttons on the outside of the remote allowing control of menus in a conventional manner. The present invention provides a TV interface and control method adapted for efficient and yet flexible searching using text entry which may advantageously employ such easy text entry to tailor a search for desired content and which can also create a flexible grid based display of content which can then be navigated by UDLR or other content surfing control. Also searching across different content types including time based content such as live TV channels and non time based content such as internet video or VOD may be provided with a single search and display.

Typically searching TV content is directed to focusing on a specific desired search result and conventional searches allow keyword searches or other specific fields to be searched directed to this end. The search results are then displayed in a list for selection. However in a TV setting searching is not a dominant manner of finding content and more typically a grid display is the primary method of finding content by “surfing” through an on screen channel guide in grid form using UDLR buttons. In another attempt to make accessing large amounts of TV content easier, many TV menu systems provide a number of category options which may alternatively be selected by going through a sequence of menu options. For example, a “sports” category may be selected and a listing of sports presented (“archery” . . . , “golf” . . . ) which can be selected and content viewed. Therefore, a viewer typically can choose from a search, a grid guide surfing selection, or a multi-layer category menu selection for going to a desired content. Each approach has its limitations and to use them all at various times requires a large number of menu layers and selection steps to be navigated. Clearly sometimes a very specific content item is sought, sometimes a whole category is of interest, and sometimes it is desired to “surf”. The multi-field search and display approach described herein allows flexibility to pursue all these options from a single search menu easily and quickly. Categories are searched along with keywords and are identified by simple entry codes (for example, a capital letter may signify a category and a lower case a keyword). The display mode dynamically adjusts to display the results in an optimal manner for the breadth of search. Specifically for a broad search (e.g., a category or group of categories) a grid display is used to allow surfing through the content options. The grid only displays content satisfy search parameters and grid size is dynamically adjusted to remove missing channels and/or time windows to provide maximum content in the display area to allow surfing by time and channel with a limited amount of wasted effort. The result can be tailored to the specific user's interests at that time.

More specifically, referring to FIGS. 1-4 an efficient and flexible multi-field TV content search method and display are illustrated. The invention is preferably used with keyboard text entry rather than UDLR entry and may use a keyboard enhanced remote as described in the above patents, but is not necessarily so limited. The menus illustrate a search adapted for example for a cable TV, IPTV or satellite TV application and may allow for easy searching for a movie in an on demand setting or a TV program or channel from an extensive TV guide listing. The menu therefore simply employs a text box and a search field selection menu for multi-field search entries. Such fields include CATEGORIES and keywords (shown as caps and regular lower case respectively-the portion in parenthesis is merely to illustrate the code example shown and is not part of the search and will normally not be displayed but could be as an aid to the user). (Other text codes for distinguishing categories may be used also, such as quotes or parenthesis, e.g., “mo” or “movie”, (mo) or (movie), etc.) Searchable fields may also include other fields such as title, actor, director, etc. The categories are limited in number and may be denoted by, e.g., two letter codes, such as MO=MOVIES, CO=COMEDY, AC=ACTION, SP=SPORTS, DR=DRAMA, HO=HORROR, etc. Keyword searchable text which is available in guides usually comprises a brief text description of the, e.g., movie, show episode or sporting event. In the multi-field search described herein the keyword search field may also include title, actor, director, etc. which may be in separate fields in the guide information as well as full keyword text search. Additional or different search field options may be employed. Multiple categories and/or keyword terms may be used to narrow the search as much as desired. Therefore, a broad search or a narrow focused search may be easily provided. For a broad search a grid display truncated to the search results may preferably be provided as shown to allow surfing of the truncated guide. The search string may be long or short and may provide a wide variety of result patterns. The search string may be stored for future use, which may be done automatically or by user selection.

Specific examples are shown in the figures for illustration purposes and without limitation. For example as shown in FIG. 2 a large TV content grid with hundreds of channels may be easily collapsed to a grid showing only western movies with Clint Eastwood with a very simple multi-field search string with two categories and a keyword covering actor fields as well as full text, i.e., “MO WE eastwood”. Although this grid is shown truncated in the channel listing it will also be truncated in time with grid time slots removed where no results are present. Although the order of the channels is shown by channel number the channel order may be prioritized for display based on another priority basis such as described below in relation to FIGS. 7-8. A slightly broader search is shown in FIG. 3 where the category western “WE” is removed. As illustrated a larger set of results may be found. In FIG. 4 a much broader search is shown with an alternative category combination search (CO/AC=comedy or action). Also a star (*) rating search parameter is included which can be used to search the star rating field provided for movies in many program guides (in the example showing only movies with a three star rating or higher). Another completely different grid is thus quickly provided. It will be appreciated that this flexibility makes a very wide range of content selection options easily available to the user.

As also illustrated in FIGS. 3 and 4 a two or multi-part display of the search results may be provided. In particular, as shown in FIG. 3 and 4 a grid display may be used to display search results with varying start times with a separate search result listing for available content which is not time limited such as shows from on demand or on line sources. Also recorded content, e.g., from a DVR, may be listed in this area or in another separate list. As another two (or more) part display, the grid may become unwieldy for odd breaks in desired content. For example, a long sequence of repeating shows on one channel may make the grid unduly long in the time direction for the easy scrolling to new content. In this case the long stretches may be detected and collapsed to one or more separate listing boxes.

In an additional aspect the search string may include excluded terms or categories. E.g., a search entry “—violence” could exclude search results with the term violence in any of the fields of the program guide. A variety of such excluding search items and fields may be used including all the ones noted, e.g., —CO means no comedies, —DO no documentaries, —$ no PPV or VOD, etc. This can effectively “prune” a large program grid more easily and quickly than requiring a term in many cases. Therefore the multi-field search specifically allows either inclusive search parameters, excluding search parameters, or both in a single search string.

Referring to FIG. 1 the interface control flow is illustrated. At 100 the search mode is entered, the search menu displayed and the search string detected. The search mode and menu displayed mat be automatic as disclosed in U.S. provisional patent application Ser. No. 60/919,683 filed Mar. 23, 2007, and utility patent application Ser. No. 12/077,891 filed Mar. 21, 2008, the disclosures of which are incorporated herein by reference in their entirety. Alternatively the search mode and search menu display may be initiated by selection through a higher level menu. The device 218, 222 (FIG. 10) displays the search menu such as in FIGS. 2-4 (without the search results initially). The streamlined search menu may be superimposed on the menu or program being viewed when the signal is received in a partial screen window. Alternatively the streamlined search menu may be displayed full screen displacing the menu or program being viewed on the screen of TV 222. In either case at 100 the user enters text (or star codes or other search symbols) to initiate searching. At 110 the search fields are determined from the search string. The guide information is then accessed at 130 and all search fields in the search string are searched. Depending on the format of the guide information this may involve several different data sets for the different fields which are all searched at 130. At 140 the search results are displayed in a time vs channel grid format which is dynamically adjusted in size based on the search results. This can be then easily scrolled through as a conventional grid to select the desired result. The search results may include results which are not time restricted for viewing and at 150 these search results are separated and are displayed in a separate group from the time based grid. It will be appreciated that steps 140 and 150 occur at the same time to the user and a single search result is displayed as in FIG. 3 or 4. The search results may be displayed immediately within the search menu window once text is entered with search fields being added as the search string progresses or alternatively the full search text may be entered before initiating the search (e.g., by enter or OK on the keyboard) and displaying the search results.

Referring to FIGS. 5-6 an alternative search and display flow and menu are described. In this embodiment the multi-field search results are displayed based on categories where multiple categories are in the search string. In the example shown in FIG. 6 the search is for any movie in the categories comedy, action or drama and the results are separately displayed as shown. The search process flow may proceed as before to search plural search fields but at 160 (FIG. 5) the display step is altered from that of FIG. 1. Although categories are a preferred display criteria other fields may be used such as display by star rating (e.g., four search result display columns for two star, three star, four star and five star movies if the search allowed two or more stars). Similarly any alternative broad search may be displayed in this way. For example, the display could be based on alternative sports, e.g., baseball, football or basketball in three columns. This column based display of alternate search requirements may be a user selected option and may be included in the menu as a display option. Also the grouping may be displayed in the form of separate grids for each search field (for example one grid for movies and one for sports which grids may be separately navigated via UDLR or other surfing style control). Alternatively the display grouping may be a combination of one or more grids and lists based on grid display criteria described below in relation to FIG. 9.

Referring to FIGS. 7-8 an alternative search and display flow and menu are described. In this embodiment the multi-field search results are displayed based on a priority determined by the search field of the result rather than a time or channel based display grid. For example, a display priority may be “title” then “actor” then any text. This may be combined for multiple terms to rate the display level. In the example shown in FIG. 8 the search is for any movie with two sets of keyword search terms. If the terms both appear in the title the result is given top priority in the display. If one of the terms is in the title it is ranked next followed by results with search terms only in the full text of the guide description. If a large number of results are found this provides an easy way to locate most likely desired results. This mode may also be combined with a time based grid described above so that the vertical grid is based on priority rather than channel number with the horizontal portion time segments as before. This alternate display mode may be a user selectable option along with the previously described display modes and may be saved on a user by user basis. Also, the priority may be created automatically by monitoring viewing preferences selected from the grid over time.

It will be appreciated that in the list based embodiments a horizontally oriented listing of search results may be provided rather than vertical as illustrated. Similarly time vs channel or time vs priority may be interchanged from horizontal to vertical in the grid based display embodiments. Also various codes may be employed to identify search fields specifically, in addition to the use of capitals, stars and parenthesis specifically mentioned above. Also, the menu search box may include separate sections for separate field by field entry of search terms. Also, the number of fields, categories and/or subcategories, may vary widely. Various other options and variations will be readily appreciated and are too numerous to list in detail.

Referring to FIG. 9 an alternative search and display flow are described. As may be appreciated from the above the multi-field search approach gives the user tremendous flexibility to tailor the breadth of the search and the user may construct a very narrow search looking for a few specific results or a broad search designed to create a large base of results to “surf” via UDLR controls. Also, both dynamically adjusted grid and list based display modes have been described above. In this embodiment the multi-field search results are displayed with an automatically adjusted display mode based on size of the search results and type of search results. More specifically, steps 100-130 may proceed as described above in relation to FIG. 1 to provide a multi-field search and results. At 180 the results are compared to predetermined size parameters to define the grid display mode. This determination is based on exceeding a predetermined number of search results and in addition one or more specific grid parameters, such as exceeding a prescribed width (typically start times) and height (typically channels). That is if N=total search results, W=number of time slots, and H=number of separate channels, then the determination at 180 may require N>X, W>Y and/or H>Z to satisfy the minimum grid size determination at 180. (For example, N>20, W>2, H>2. These numbers are of course potentially settable over a wide range. Also these numbers may be user settable.) If this determination at 180 is YES then the flow proceeds at 140 and 150 as described before to display the results in a size adjusted grid. If the determination is NO then the results are displayed as a list at 190. The list may be prioritized in a predetermined manner, such as alphabetically or start time or dynamically based on the search parameters as described above in relation to FIGS. 7 and 8. Also at 180 a relation between W and H may be required (e.g., W/H in range) and this determination may vary by grid segments. The grid determination may then be satisfied for less than all the results. For example, for a relatively small number of results spread over time the grid may automatically be collapsed to a simple list for that portion. For example, less than 10-20 results spread over relatively many time grid segments may trigger collapse of that portion of the grid to a list. Therefore, both grid and list display may be provided simultaneously for different time portions of the grid.

Referring to FIG. 10 an improved entertainment system employing the search features in accordance with the present invention is illustrated. As shown, the entertainment system includes a TV monitor 222 which is coupled to a data processing device 218 of the type which receives text input control signals for searching as described above and controls the interface displayed on the TV. Also, additional devices or inputs may be provided to the entertainment system, e.g., a DVR 272, wired or wireless networked device coupled to a PC or other media server and other video and data inputs indicated generally by inputs 216 and 265 in FIG. 10. Also shown is remote 10, illustrated in both the first (open) and second (closed) configurations as described in the above noted patents incorporated herein. Remote 10 provides typical TV type control signals to the entertainment system in the second (closed) position, such as volume up/down and power, and text input control signals in the first (open) position as described above, and optionally detects opening and transmits the text input activation signal as described at 100 above.

Although the interface control described above is preferably employed with the folding remote illustrated in FIG. 10 and described in the above patents incorporated by reference, the keyboard text entry at 100 above and ensuing control flow may also be by another means. In such alternate embodiments the keyboard may be configured differently than the preferred folding design or may even be separate from the remote.

It will be appreciated by those skilled in the art that the foregoing is merely an illustration of the present invention in currently preferred implementations. A wide variety of modifications to the illustrated embodiments are possible while remaining within the scope of the present convention. Therefore, the above description should not be viewed as limiting but merely exemplary in nature.

What is claimed is:

1. A method for searching and displaying content in a TV environment, comprising:
entering text into a search menu in response to text entry from a remote control or keyboard;
searching TV content including programs having varying start times based on the entered text;
displaying the search results on a menu on the TV screen in a list format if the number of search results is less than a predetermined number; and
displaying the search results on menu on the TV screen in a time based grid format if the number of search results is greater than said predetermined number.

2. A method for searching and displaying content in a TV environment as set out in claim 1, wherein the predetermined number is user settable.

3. A method for searching and displaying content in a TV environment as set out in claim 1, wherein if N=total search results, W=number of time slots, and H=number of separate channels, then the a grid display determination is made if the number of search results satisfies N>X, W>Y and/or H>Z.

4. A method for searching and displaying content in a TV environment as set out in claim 1, wherein the list is prioritized based on a user defined criteria.

5. A method for searching and displaying content in a TV environment as set out in claim 1, wherein the grid is prioritized based on a user defined criteria.

6. A method for searching and displaying content in a TV environment as set out in claim 1, wherein the list or grid is prioritized dynamically based on the search parameters.

7. A method for searching and displaying content in a TV environment, comprising:
entering text into a search menu in response to text entry from a remote control or keyboard;
searching video content including plural categories of content based on the categories selected by the entered text; and
displaying the search results on a menu on the TV screen in a format with one or more separate lists or grids for each category.

8. A method for searching and displaying content in a TV environment as set out in claim 7, wherein the list is prioritized based on a user defined criteria.

9. A method for searching and displaying content in a TV environment as set out in claim 7, wherein the grid is prioritized based on a user defined criteria.

10. A method for searching and displaying content in a TV environment as set out in claim 7, wherein the list or grid is prioritized dynamically based on the search parameters.

11. A method for searching and displaying content in a TV environment as set out in claim 7, wherein the plural categories comprise categories such as action, comedy, and drama.

12. A method for searching and displaying content in a TV environment as set out in claim 7, wherein the plural categories comprise categories such as pay per view movies and free movies.

13. A method for searching and displaying content in a TV environment, comprising:
entering text into a search menu in response to text entry from a remote control or keyboard;
searching video content including video content having varying start times and video content having no fixed start time based on the entered text; and
displaying the search results on a menu on the TV screen in a list format for the search results having no fixed start time and in a time based grid format for the search results having varying start times.

14. A method for searching and displaying content in a TV environment as set out in claim 13, wherein said content having no fixed start time comprises internet accessed video content.

15. A method for searching and displaying content in a TV environment as set out in claim 13, wherein said content having no fixed start time comprises video on demand content.

16. A method for searching and displaying content in a TV environment, comprising:
entering text into a search menu in response to text entry from a remote control or keyboard, the search parameters covering plural separate search fields based on search codes and keyword searches; and
displaying the search results on a menu on the TV screen in dynamically adjusted grid format having varying start times with channels and time slots removed for grid results without matching content and satisfying a grid display criteria.

17. A method for searching and displaying content in a TV environment as set out in claim 16, wherein the search fields are based on capitalized text and keywords on uncapitalized text.

18. A method for searching and displaying content in a TV environment as set out in claim 16, wherein the grid display criteria comprise a number of blank grid positions exceeding a predetermined number.

19. A method for searching and displaying content in a TV environment as set out in claim 16, wherein the search parameters are stored on a user by user basis.

20. A method for searching and displaying content in a TV environment as set out in claim 16, wherein the search fields are based on symbols in addition to text.
